(19) United States
(12) Patent Application Publication
(10) Pub. No.: US 2018/0041878 A1
(43) Pub. Date: Feb. 8, 2018

(54) MULTIPLE VOICE GREETING SYSTEM AND METHOD

(71) Applicant: Rose-Guerdithe Dorsaint, Sarasota, FL (US)

(72) Inventor: Rose-Guerdithe Dorsaint, Sarasota, FL (US)

(21) Appl. No.: 15/669,796

(22) Filed: Aug. 4, 2017

Related U.S. Application Data
(60) Provisional application No. 62/371,177, filed on Aug. 4, 2016.

(51) Int. Cl. H04W 4/12; H04W 4/22; H04M 1/725; H04M 3/533; H04M 3/42

(52) U.S. Cl. CPC H04W 4/12; H04M 3/53383; H04M 3/42059; H04M 1/72525; H04M 1/72536; H04W 4/22

(57) ABSTRACT

A multiple voice greeting system and method is a computer-based system and method of use allowing users and subscribers to exchange personal voice messages; to select and deliver voice information; and to process transactions relating to individuals, organizations, products and services, using a mobile device.

### CROSS REFERENCE TO RELATED APPLICATION

The present application is related to and claims priority to U.S. Provisional Patent Application No. 62/371,177 filed Aug. 4, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of voicemail greeting management and more specifically relates to a custom voicemail greeting assignment for callers.

### 2. Description of Related Art

Voice mail systems may be used to retrieve messages in an absence. Some may be computer-based systems that allow users and subscribers to exchange personal voice messages; to select and deliver voice information; and to process transactions relating to individuals, organizations, products and services, using an ordinary telephone. The term is also used more broadly to denote any system of conveying a stored telecommunications voice messages, including using an answering machine. Most cell phone services offer voice-mail as a basic feature. Currently, most voicemail greetings have to be recorded to be used as a general greeting for all callers. This does not allow individuals or businesses to cater to their audience. There is some information that individuals may not want to share with a broad audience, however would like to relay to close family, friends, or clients. There is often a need to convey a specific message to a specific person or group of people, but a general voicemail greeting does not allow for this. Voicemail greetings tend to sound generic and robotic and do not allow for much human interaction. A suitable solution is desired.

U.S. Pat. No. 8,265,603 to Policarpo Wood, et al. relates to a creation and management of voicemail greetings for mobile communication devices. The described creation and management of voicemail greetings for mobile communication devices includes methods, graphical user interfaces and devices for creation and management of voicemail greetings. A user of a mobile communication device can create and manage multiple voicemail greetings. In one aspect, a user of a mobile communication device can create customized voicemails. The customized voicemails can be assigned to specific contacts (or groups of contacts) known to the mobile communication device. The customized voicemail greetings can also have controlled expiration dates. In another aspect, customized voicemails can be assigned to incoming calls in real-time.

### BRIEF SUMMARY OF THE INVENTION

In view of the foregoing disadvantages inherent in the known voicemail greeting management art, the present disclosure provides a novel multiple voice greeting system and method. The general purpose of the present disclosure, which will be described subsequently in greater detail, is to provide a voice mail system; a computer-based system that allows users and subscribers to exchange personal voice messages; to select and deliver voice information; and to process transactions relating to individuals, organizations, products and services, using an ordinary telephone.

A multiple voice greeting system and method is disclosed herein. The multiple voice greeting system and method includes a method of managing greetings on a multiple voice greeting system including the steps of: recording at least one greeting; specifying contact-information of a contact associated with the at least one greeting; receiving an incoming call from the contact having unique the contact-information; analyzing the contact-information of the contact of the incoming call to determine which of the at least one greeting is an appropriate greeting alternative for the contact; directing the incoming call to a voicemail storage on a mobile device is determined; playing an appropriate greeting based on the contact-information of the contact from the incoming call; and intaking a voicemail recording for later viewing and listening on a display screen of the mobile device.

A user of a mobile device may create and manage multiple voicemail greetings. In one aspect, a user of a mobile device can create customized pre-recorded voicemails. The customized pre-recorded voicemails may then be assigned to specific contacts or groups of contacts stored on the mobile device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a multiple voice greeting system and method, constructed and operative according to the teachings of the present disclosure.

FIG. 1 is a perspective view of the multiple voice greeting system and method during an ‘in-use’ condition, according to an embodiment of the disclosure.

FIG. 2 is a flowchart diagram of the multiple voice greeting system and method of FIG. 1, according to an embodiment of the present disclosure.

FIG. 3 is a flowchart diagram of the multiple voice greeting system and method of FIG. 1, according to an embodiment of the present disclosure.

FIG. 4 is a flowchart diagram of the multiple voice greeting system and method of FIG. 1, according to an embodiment of the present disclosure.

FIG. 5 is a flowchart diagram illustrating a method of use for the multiple voice greeting system and method, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to voicemail greeting management and more particularly to a multiple voice greeting system and method as used to improve the custom voicemail greeting assignment for callers.

Generally, the present invention facilitates an optional way to leave a voicemail greeting for specific individuals. It improves communication by allowing a person to share their status and provides a secure method for relaying that information to specific people. This enables multiple individuals to receive a separate and personalized voicemail greeting depending on user preferences. It provides a better and more innovative option for voicemail greetings.

The present invention allows users to assign specific greetings to each phone contact and enables users to change greetings when desired for one or more contacts. Multiple voice greeting system changes the way users leave voicemail greetings and messages. This application allows users to sync the application with their phone contacts, which enables them to use separate and personalized voicemail greetings for select individuals in their contact list, either in groups or individually. Multiple personalized messages can be recorded by the user and then the user can apply the selected recorded messages to select individuals in their contact lists. Each selected user will hear his/her assigned greeting, even when calling consecutively.

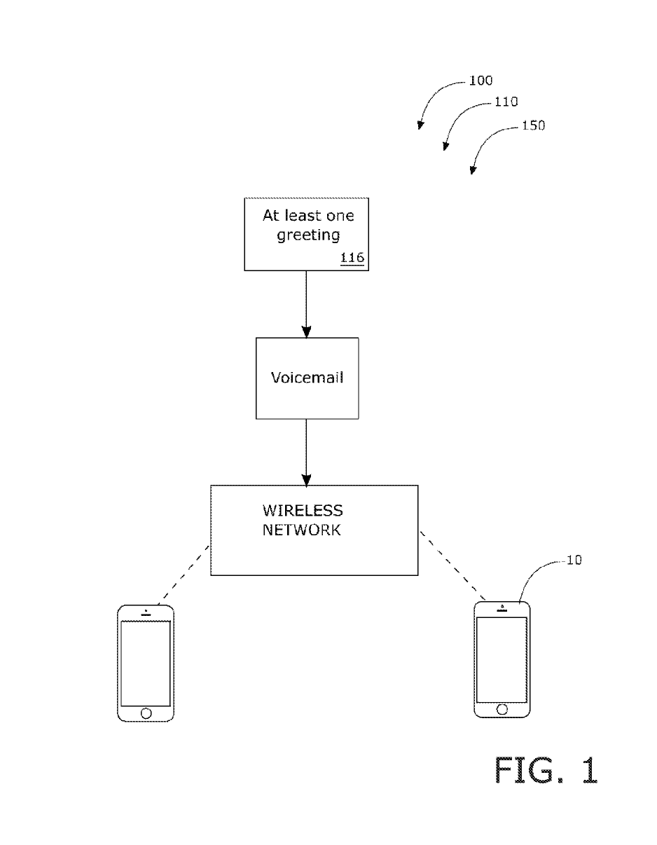

Referring now more specifically to the drawings by numerals of reference, there is shown in FIGS. 1-5, various views and flowcharts of a multiple voice greeting system and method 100. FIG. 1 shows a multiple voice greeting system and method 100 during an ‘in-use’ condition 150, according to an embodiment of the present disclosure. As illustrated, the multiple voice greeting system and method 100 allows a user of a mobile device 10 may create and manage multiple voicemail greetings. In one aspect, a user of a mobile device 10 can create customized pre-recorded voicemails. The customized pre-recorded voicemails may then be assigned to specific contacts or groups of contacts stored on the mobile device 10.

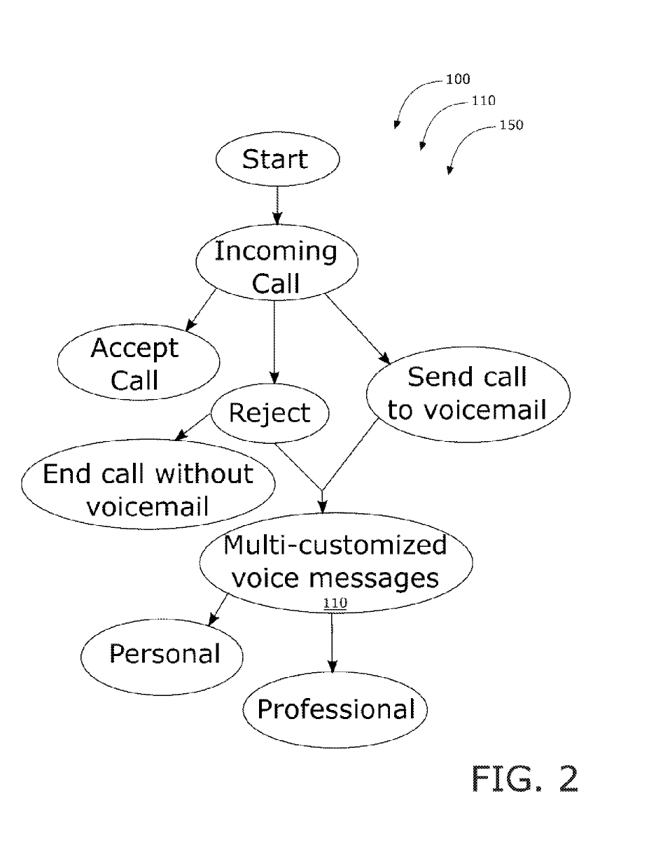

FIG. 2 shows a flowchart diagram of the multiple voice greeting system and method 100 of FIG. 1, according to an embodiment of the present disclosure. As above, the method of managing greetings on a multiple voice greeting system 100 includes the steps of: recording at least one greeting 116; specifying contact-information of a contact associated with the at least one greeting 116; receiving an incoming call from the contact having unique contact-information; analyzing the contact-information of the contact of the incoming call to determine which of the at least one greeting(s) 116 is an appropriate greeting 116 alternatives for the contact; directing the incoming call to a voicemail storage on a mobile device 10 is determined; playing an appropriate at least one greeting 116 based on the contact-information of the contact from the incoming call; and intaking a voicemail recording for later viewing and listening on a display screen (and speaker) of the mobile device 10.

The method of managing greetings on a multiple voice greeting system may further comprise the step of identifying a caller identification associated with the incoming call to identify the contact; downloading a mobile application on the mobile device 10; providing access to settings on the mobile device 10 for the mobile application. The mobile device 10 may comprise a mobile phone configured to receive incoming calls. A user may view the multiple voice greeting system via the mobile application on the mobile device 10. The method may further include the step of syncing the mobile application with contacts on the mobile device 10.

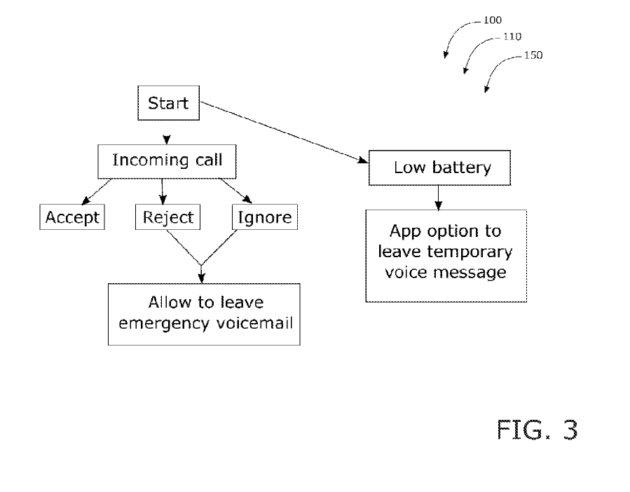

FIG. 3 shows a flowchart diagram of the multiple voice greeting system and method 100 of FIG. 1, according to an embodiment of the present disclosure. In certain embodiments, the method further comprises the step of recording an emergency voicemail recording. With this feature the user may then be alerted of the emergency voicemail recording with an alert that cannot be silenced.

In other embodiments, a caller may be directed to leave a temporary voicemail recording when the mobile device 10 has a low-battery status. With this feature, contacts or groups may be notified that the mobile device 10 has a low-battery. Other features may be available to suit user needs.

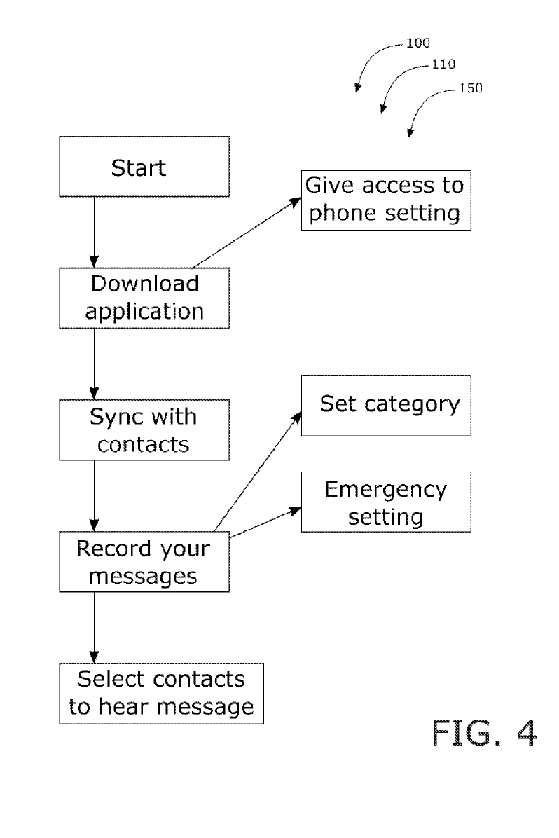

FIG. 4 shows a flowchart diagram of the multiple voice greeting system and method 100 of FIG. 1, according to an embodiment of the present disclosure. The multiple voice greeting system disclosed herein preferably comprises a mobile-application supporting a software of the multiple voice greeting system, a mobile device 10 in communication with the mobile-application and is configured to receive an incoming call, store a plurality of contacts, at least one greeting 116, and at least one voicemail recording.

The mobile device 10 includes at least a display, a memory and a processor in functional combination. The mobile-application may be activated when receiving the incoming call. The mobile-application is supported on the mobile device 10 which may include a mobile phone. The mobile-application provides at least one greeting 116 based on a user-selected setting and caller-identification of the plurality of contacts of the incoming call displayed on the display of the mobile device 10. The mobile-application is configured to analyze the incoming call and play an appropriate pre-determined at least one greeting 116 as appropriate.

The at least one greeting 116 may be a personal, default, professional work-related or other greeting to be played to selected contacts. The at least one greeting 116 may be pre-recorded by a user. The at least one greeting 116 is displayed on the mobile device 10 for selecting the at least one greeting for the plurality of contacts. The at least one greeting 116 may be assigned to at least one of the plurality of contacts. When the at least one voicemail recording is recorded a notification is sent to a user.

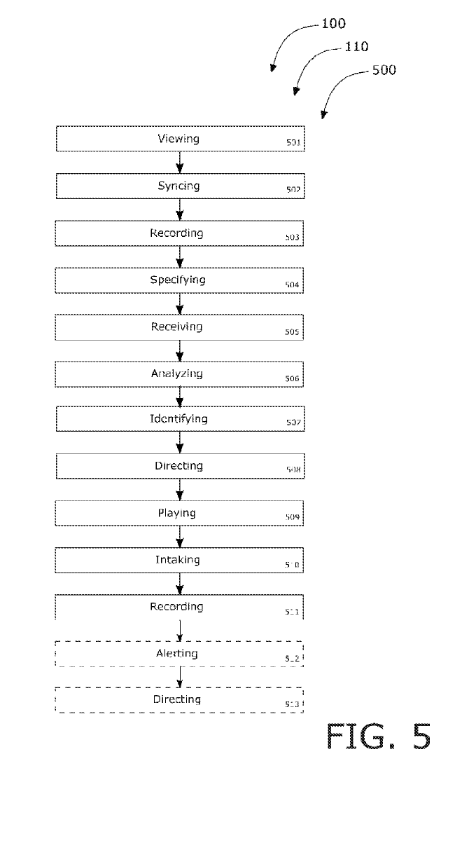

FIG. 5 shows a flow diagram illustrating a method for managing greetings on a multiple voice greeting system. As illustrated, the method 500 for managing greetings on a multiple voice greeting system may include the steps of: step one 501, viewing the multiple voice greeting system via a mobile application on a mobile device 10; step two 502, syncing the mobile application with contacts; step three 503, recording at least one greeting 116; step four 504, specifying contact-information of a contact associated with the at least one greeting 116; step five 505, receiving an incoming call from the contact having unique the contact-information; step six 506, analyzing the contact-information of the contact of the incoming call to determine which of the at least one greeting 116 is an appropriate response of the at least one greeting 116 for the contact; step seven 507, identifying a caller identification associated with the incoming call to identify the contact; step eight 508, directing the incoming call to a voicemail storage on a mobile device 10; step nine 509, playing an appropriate one of the at least one greeting(s) 116 based on the contact-information of the contact from the incoming call; step ten 510, intaking a voicemail recording for later viewing and listening on a display screen of the mobile device 10; step eleven 511, recording an emergency voicemail recording; step twelve 512, alerting a user of the emergency voicemail recording; and step thirteen 513, directing the incoming call to leave a temporary voicemail recording when the mobile device 10 has a low-battery status.

It should be noted that step twelve 512 and step thirteen 513 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for managing greetings on a multiple voice greeting system [NOTE: e.g., different step orders within above-mentioned list, elimination or addition of certain steps, including or excluding certain maintenance steps, etc.], are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method of managing greetings on a multiple voice greeting system, said method comprising the steps of:
recording at least one greeting;
specifying contact-information of a contact associated with said at least one greeting;
receiving an incoming call from said contact having unique said contact-information;
analyzing said contact-information of said contact of said incoming call to determine which of said at least one greeting is an appropriate said at least one greeting alternatives for said contact;
directing said incoming call to a voicemail storage on a mobile device is determined;
playing an appropriate said at least one greeting based on said contact-information of said contact from said incoming call; and
intaking a voicemail recording for later viewing and listening on a display screen of said mobile device.

2. The method of managing greetings on a multiple voice greeting system according to claim 1, said method further comprising the step of: identifying a caller identification associated with said incoming call to identify said contact.

3. The method of managing greetings on a multiple voice greeting system according to claim 1, said method further comprising the step of: downloading a mobile application on said mobile device.

4. The method of managing greetings on a multiple voice greeting system according to claim 3, said method further comprising the step of: providing access to settings on said mobile device for said mobile application.

5. The method of managing greetings on a multiple voice greeting system according to claim 1, wherein said mobile device comprises a mobile phone.

6. The method of managing greetings on a multiple voice greeting system according to claim 3, said method further comprising the step of: viewing said multiple voice greeting system via said mobile application on said mobile device.

7. The method of managing greetings on a multiple voice greeting system according to claim 1, said method further comprising the step of: syncing said mobile application with said contacts.

8. The method of managing greetings on a multiple voice greeting system according to claim 1, said method further comprising the step of: recording an emergency said voicemail recording.

9. The method of managing greetings on a multiple voice greeting system according to claim 8, said method further comprising the step of: alerting a user of said emergency said voicemail recording.

10. The method of managing greetings on a multiple voice greeting system according to claim 1, said method further comprising the step of: directing said incoming call to leave a temporary said voicemail recording when said mobile device has a low-battery status.

11. A multiple voice greeting system, said system comprising:
a mobile-application supporting a software of said multiple voice greeting system;
a mobile device in communication with said mobile-application and configured to receive an incoming call, store a plurality of contacts, at least one greeting, and at least one voicemail recording;
wherein said mobile device includes a display, a memory and a processor in functional combination;
wherein said mobile-application is activated when receiving said incoming call;
wherein said mobile-application is supported on said mobile device;
wherein said mobile-application provides at least one greeting based on a user-selected setting and caller-identification of said plurality of contacts of said incoming call displayed on said display of said mobile device; and
wherein said mobile-application is configured to analyze said incoming call and play an appropriate pre-determined at least one greeting as appropriate.

12. The multiple voice greeting system according to claim 11, wherein said at least one greeting is a personal said at least one greeting to selected said contact.

13. The multiple voice greeting system according to claim 11, wherein said at least one greeting is a professional work-related said at least one greeting.

14. The multiple voice greeting system according to claim 11, wherein said at least one greeting comprises a default said at least one greeting.

15. The multiple voice greeting system according to claim 11, wherein said at least one greeting is pre-recorded.

16. The multiple voice greeting system according to claim 11, wherein said mobile device comprises a mobile phone.

17. The multiple voice greeting system according to claim 11, wherein said at least one greeting is displayed on said mobile device for selecting said at least one greeting for said plurality of contacts.

18. The multiple voice greeting system according to claim 11, wherein said at least one greeting is assigned to at least one of said plurality of contacts.

19. The multiple voice greeting system according to claim 11, wherein when said at least one voicemail recording is recorded a notification is sent to a user.

20. A method of managing greetings on a multiple voice greeting system, said method comprising the steps of:
viewing said multiple voice greeting system via a mobile application on a mobile device;
syncing said mobile application with contacts;
recording at least one greeting;
specifying contact-information of a contact associated with said at least one greeting;
receiving an incoming call from said contact having unique said contact-information;
analyzing said contact-information of said contact of said incoming call to determine which of said at least one greeting is an appropriate response of said at least one greeting for said contact;
identifying a caller identification associated with said incoming call to identify said contact;
directing said incoming call to a voicemail storage on a mobile device;
playing an appropriate one of said at least one greeting based on said contact-information of said contact from said incoming call;
intaking a voicemail recording for later viewing and listening on a display screen of said mobile device;
recording an emergency said voicemail recording;
alerting a user of said emergency said voicemail recording; and
directing said incoming call to leave a temporary said voicemail recording when said mobile device has a low-battery status.
